(19) United States
(12) Patent Application Publication
(10) Pub. No.: US 2013/0003859 A1
(43) Pub. Date: Jan. 3, 2013

(54) TRANSITION BETWEEN RUN AND LEVEL CODING MODES

(75) Inventors: Marta Karczewicz, San Diego, CA (US); Liwei Guo, San Diego, CA (US); Xianglin Wang, San Diego, CA (US)

(73) Assignee: QUALCOMM INCORPORATED, San Diego, CA (US)

(21) Appl. No.: 13/467,756

(22) Filed: May 9, 2012

Related U.S. Application Data
(60) Provisional application No. 61/503,533, filed on Jun. 30, 2011.
(60) Provisional application No. 61/552,357, filed on Oct. 27, 2011.

(51) Int. Cl. H04N 7/26

(52) U.S. Cl. 375/240.24; 375/240.26; 375/E07.085; 375/E07.14; 375/E07.125

(57) ABSTRACT

This disclosure describes techniques for coding transform coefficients for a block of video data. According to some aspects of this disclosure, a video coder (e.g., encoder, decoder) may code a first coefficient of a leaf-level unit of video data using a run encoding mode. The coder may code a second coefficient of the leaf-level unit of video data using a level encoding mode. After coding at least one coefficient using the level coding mode, the coder may use the run coding mode to code a third other coefficient of the leaf-level unit of video data. According to other aspects, an encoder may signal, to a decoder, at least one indication of a transition between level and run coding modes. According to still other aspects, a coder may automatically determine when to transition between the level and run coding modes.

This application claims priority to the following U.S. Provisional Applications, the entire contents each of which is incorporated herein by reference:

U.S. Provisional Application 61/503,533, filed Jun. 30, 2011; and

U.S. Provisional Application 61/552,357, filed Oct. 27, 2011.

### TECHNICAL FIELD

This disclosure relates to video coding and compression. More specifically, this disclosure is directed to techniques for scanning quantized transform coefficients.

### BACKGROUND

In video coding, to compress an amount of data used to represent video data, a video encoder may entropy encode the video data. According to some aspects of entropy encoding, the video encoder may scan a two-dimensional matrix of transform coefficients that represent pixels of an image, to generate a one-dimensional vector of the transform coefficients. A video decoder may decode the video data. As part of the decoding process, the video decoder may scan the one-dimensional vector of transform coefficients, to reconstruct the two-dimensional matrix of transform coefficients.

### BRIEF DESCRIPTION OF DRAWINGS

FIG. 1 is a block diagram that illustrates one example of a video encoding and decoding system configured to operate according to the techniques of this disclosure.

FIG. 2 is a block diagram that illustrates one example of a video encoder configured to operate according to the techniques of this disclosure.

FIG. 3 is a block diagram that illustrates one example of a video decoder configured to operate according to the techniques of this disclosure.

FIG. 4 is a conceptual diagram that depicts one example of a scan of transform coefficients of video data consistent with one or more aspects of this disclosure.

FIG. 5 is a flow diagram that illustrates one example of a method of operating a coder to transition between a level coding mode and a run coding mode when performing a scan of transform coefficients consistent with one or more aspects of this disclosure.

FIG. 6 is a flow diagram that illustrates one example of a method of operating a coder to transition from run coding mode to level coding mode consistent with one or more aspects of this disclosure.

FIG. 7 is a flow diagram that illustrates one example of a method of operating a coder to transition from level coding mode to run coding mode consistent with one or more aspects of this disclosure.

FIG. 8 is a flow diagram that illustrates one example of a method of operating an encoder to generate a syntax element that indicates a transition between level coding mode and run coding mode consistent with one or more aspects of this disclosure.

FIG. 9 is a flow diagram that illustrates one example of a method of operating decoder to transition between level coding mode and run coding mode based on at least one a syntax element read by the decoder consistent with one or more aspects of this disclosure.

FIG. 10 is a flow diagram of a method of operating a coder to automatically determine when to transition from level coding mode to run coding mode consistent with one or more aspects of this disclosure.

### SUMMARY

In video coding, to compress an amount of data used to represent video data, a video encoder may entropy encode the video data. To entropy encode a unit of video data, the video encoder may perform a scan of a two-dimensional matrix of transform coefficients generate a one-dimensional vector that represents the video data. According to some examples, a video encoder may be configured to first use a run coding mode when performing a scan of transform coefficients of a leaf-level unit of video data, and then transition to using a level coding mode for the remaining coefficients of the leaf-level unit. According to these examples, the encoder may transition from the level mode back to the run mode based on one or more thresholds Th_level and Th_num, described in further detail below.

According some aspects of this disclosure, in addition to transitioning between run and level coding modes as described above, a coder may also be configured to transition from the level coding mode back to the run coding mode, as the coder performs a scan of the leaf-level unit. In some examples, transitioning from using the level coding mode to using the run coding mode to code the coefficients may enable the coder to better adapt the scan of transform coefficients to local content and/or context of a leaf-level unit of video data being encoded, which may improve coding efficiency.

According to other aspects of this disclosure, a video encoder may generate at least one syntax element that indicates, to a decoder, a transition between the level coding mode and run coding mode (e.g., a transition from level to run, or from run to level). In some examples, generating at least one syntax element that indicates, to a decoder, a transition between level and run coding modes to code the coefficients may enable the encoder to better control operation of the decoder to decode coefficients. According to these examples, the encoder may better adapt operation of the decoder to local content and/or context of a leaf-level unit of video data being encoded, which may thereby improve coding efficiency.

According to still other aspects of this disclosure, a coder (e.g., video encoder, decoder) may automatically determine when to transition between the level and run coding modes (e.g., from level to run, or from run to level). For example, the coder may automatically determine when to transition based on one or more characteristics of video data being coded, or based on statistics regarding previously coded video data. In some examples, automatically determining when to transition between level and run coding modes to code the coefficients may enable the encoder to better adapt operation of the coder to local content and/or context of a leaf-level unit of video data being encoded without generating one or more syntax elements as described above, which may thereby improve coding efficiency.

In one example, this disclosure describes a method of coding a block of video data, the method comprising coding at least a first coefficient of a leaf-level unit of video data using a run encoding mode, coding at least a second coefficient of the leaf-level unit of video data using a level encoding mode, and after coding the first coefficient using the level coding mode, using the run coding mode to code at least a third coefficient of the leaf-level unit of video data.

In another example, this disclosure describes a device configured to code a block of video data, the device comprising a video coding module configured to code at least a first coefficient of a leaf-level unit of video data using a run encoding mode, code at least a second coefficient of the leaf-level unit of video data using a level encoding mode, and after coding the second coefficient using the level coding mode, use the run coding mode to code at least a third coefficient of the leaf-level unit of video data.

In another example, this disclosure describes a computer-readable storage medium that stores instructions that, when executed, cause a computing device to code at least a first coefficient of a leaf-level unit of video data using a run encoding mode, code at least a second coefficient of the leaf-level unit of video data using a level encoding mode, and after coding the second coefficient using the level coding mode, use the run coding mode to code at least a third coefficient of the leaf-level unit of video data.

In another example, this disclosure describes a device configured to code a block of video data, the device comprising means for coding at least a first coefficient of a leaf-level unit of video data using a run encoding mode, means for coding at least a second coefficient of the leaf-level unit of video data using a level encoding mode, and means for, after coding the second coefficient using the level coding mode, using the run coding mode to code at least a third coefficient of the leaf-level unit of video data.

In another example, this disclosure describes a method of encoding a unit of video data, the method comprising coding a first plurality of transform coefficients of a leaf-level unit of video data using a first coding mode, coding a second plurality of transform coefficients of the leaf-level unit using a second coding mode, and outputting as part of a coded bitstream, an indication of one or more of a transition from the run coding mode to the level encoding mode and a transition from the level encoding mode to the run encoding mode.

In another example, this disclosure describes a device configured to encode a leaf-level unit of video data, the device comprising an encoding module configured to code a first plurality of transform coefficients of a unit of video data using a first coding mode, code a second plurality of transform coefficients of the unit of video data using a second coding mode, and output, as part of a coded bitstream, an indication of one or more of a transition from the run coding mode to the level encoding mode and a transition from the level encoding mode to the run encoding mode.

In another example, this disclosure describes a computer-readable storage medium comprising instructions configured to cause a computing device to code a first plurality of transform coefficients of a unit of video data using a first coding mode, code a second plurality of transform coefficients of the unit of video data using a second coding mode, and output, as part of a coded bitstream, an indication of one or more of a transition from the run coding mode to the level encoding mode and a transition from the level encoding mode to the run encoding mode.

In another example, this disclosure describes a device configured to encode a unit of video data, the device comprising means for coding a first plurality of transform coefficients of a unit of video data using a first coding mode, means for coding a second plurality of transform coefficients of the unit of video data using a second coding mode, and means for outputting, as part of a coded bitstream, an indication of one or more of a transition from the run coding mode to the level encoding mode and a transition from the level encoding mode to the run encoding mode.

In another example, this disclosure describes method of decoding a unit of video data, the method comprising using a first coding mode to decode a first plurality of coefficients of a leaf-level unit of transform coefficients, and transitioning to using a second coding mode to encode a second plurality of coefficients of the scan based on at least one syntax element read from an entropy encoded bit stream.

In another example, this disclosure describes a device configured to decode a unit of video data, the device comprising a decoding module configured to use a first coding mode to decode a first plurality of coefficients of a leaf-level unit of transform coefficients, and transition to using a second coding mode to encode a second plurality of coefficients of the scan based on at least one syntax element read from an entropy encoded bit stream.

In another example, this disclosure describes a computer-readable storage medium that includes instructions that, when executed, cause a computing device to use a first coding mode to decode a first plurality of coefficients of a leaf-level unit of transform coefficients, and transition to using a second coding mode to encode a second plurality of coefficients of the scan based on at least one syntax element read from an entropy encoded bit stream.

In another example, this disclosure describes a device configured to decode a block of video data, the device comprising means for using a first coding mode to decode a first plurality of coefficients of a leaf-level unit of transform coefficients, and means for transitioning to using a second coding mode to encode a second plurality of coefficients of the scan based on at least one syntax element read from an entropy encoded bit stream.

The details of one or more examples are set forth in the accompanying drawings and the description below. Other features, objects, and advantages of the invention will be apparent from the description and drawings, and from the claims.

### DETAILED DESCRIPTION

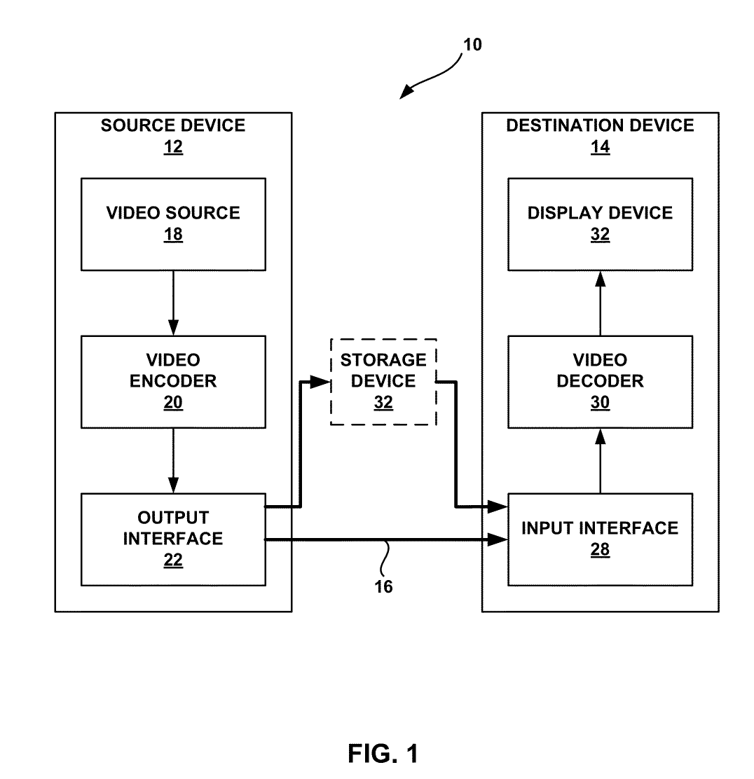

FIG. 1 is a block diagram that illustrates an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 32. Similarly, encoded data may be accessed from storage device 32 by input interface 28. Storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 32 may correspond to a file server or another intermediate storage device that may hold the encoded video generated by source device 12. Destination device 14 may access stored video data from storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 32 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 12. The encoded video data may be transmitted directly to destination device 14 via output interface 22 of source device 20. The encoded video data may also (or alternatively) be stored onto storage device 32 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 32, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Such a final, unsplit child node of a video data structure is referred to as a leaf-level unit herein. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). The phrase “leaf-level unit” as described herein may refer to any undivided unit of video data on which a coder may perform a scan of transform coefficients. One example of such a leaf-level unit is leaf node TU of the RQT. Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more transform units (TUs). Following prediction, video encoder 20 may calculate residual values corresponding to the PU. The residual values comprise pixel difference values that may be transformed into transform coefficients, quantized, and scanned using the TUs to produce serialized transform coefficients for entropy coding. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not, although other context information may also be used in CABAC. The probability determination may be based on one or more contexts assigned to the symbol. To perform CAVLC, video encoder 20 may select a variable length code for a symbol to be transmitted. Codewords in VLC may be constructed such that relatively shorter codes correspond to more probable symbols, while longer codes correspond to less probable symbols. VLC tables (as well as entries from the tables) may be selected based on contexts. In this way, the use of VLC may achieve a bit savings over, for example, using equal-length codewords for each symbol to be transmitted.

Video encoder 20 of source device 12 may scan transform coefficients of a leaf-level unit of video data (e.g., a leaf node of a quadtree or other data structure) that includes a two-dimensional matrix of transform coefficients (e.g., that each corresponds to pixels of a displayed image) into a one-dimensional vector that represents the transform coefficients. Such a scan may be based on a predetermined scan pattern, such as a horizontal, zig-zag, vertical, inverse zig-zag scan, or any other predetermined scan pattern. In other examples, video encoder 20 may adaptively update the order of a transform coefficient scan, based on values of coefficients at positions within previously decoded blocks of video data.

According to some examples, video encoder 20 performs an inverse zig-zag scan of transform coefficients. According to such an inverse zig-zag scan, video encoder 20 begins encoding at a location that corresponds to a last non-zero coefficient (e.g., a non-zero coefficient furthest from an upper left position of the leaf-level unit). According to the inverse zig-zag scan, video encoder 20 codes transform coefficients in a zigzag pattern from the last non-zero coefficient to an upper left position of the leaf-level unit.

In some examples, when video encoder 20 performs the inverse zig-zag scan of a leaf-level unit, video encoder 20 first encodes a first plurality of coefficients using a run coding mode, and then uses a level coding mode to encode the remaining coefficients of the leaf-level unit. Changing from run coding mode to level coding mode can improve coding efficiency in some cases, such as when coefficient values become large and most or all remaining coefficients in the scan are significant.

According to a run encoding mode, if a coefficient has a magnitude greater than zero, video encoder 20 signals a level_ID syntax element for the scanned coefficient. The level_ID syntax element indicates whether the coefficient has an amplitude of 1 or greater than 1. For example, video encoder 20 may assign level_ID a value of zero (0) if the coefficient has a magnitude equal to one (1). However, if coefficient has a value greater than one (1), video encoder 20 may assign level_ID a value of one (1). In some examples, if level_ID has a value of one, video encoder 20 also signals a level syntax element. The level syntax element indicates a magnitude of the transform coefficient. For example, video encoder 20 may assign the level syntax element a value of zero if the coefficient has a magnitude of two (2), a value of one if the coefficient has a magnitude of three (3), a value of two (2) if the coefficient has a magnitude of four (4), and so on. According to the level coding mode, for each remaining coefficient of the leaf-level unit, the encoder signals a (|level|) syntax element, which indicates a magnitude of the coefficient. According to the level mode, encoder 20 does not signal the run and level_ID syntax elements described above with respect to the run coding mode.

In some examples, video encoder 20 transitions from the run coding mode to the level coding mode based on a predetermined threshold stored in memory that is based on determined magnitudes for one or more already coded coefficients of the inverse zig-zag scan of the leaf-level unit. According to these examples, a first predetermined threshold Th_num stored in memory indicates a number of previously coded transform coefficients with a magnitude larger than a second predetermined threshold Th_level, which is also stored in memory. A value of the predetermined threshold Th_num is based on a size of a block of video data being coded. According to these examples, video encoder 20 counts a number N of previously coded transform coefficients of the leaf-level unit with a value greater than the predetermined threshold Th_level. If the counted number N is greater than the predetermined threshold Th_num, video encoder 20 transitions from the run coding mode to the level coding mode. According to these examples, once video encoder 20 has transitioned from the run coding mode to the level coding mode based on the predetermined thresholds Th_level and Th_num, video encoder 20 uses the level coding mode to encode the remaining transform coefficients of the leaf-level unit. For a next leaf-level unit, the video encoder 20 again begins encoding transform coefficients using the run coding mode and, if the counted number N exceeds the predetermined threshold Th_num, video encoder 20 transitions to the level mode for the remaining coefficients of the next leaf-level unit.

This disclosure describes improved techniques for encoding and/or decoding a leaf-level unit of video data. More specifically, this disclosure describes various techniques for transitioning between run and level coding modes when performing a transform coefficient scan of a leaf-level unit of video data. This disclosure describes techniques for transitioning from run coding mode to level coding mode, as well as techniques for transitioning from the level coding mode back to the run coding mode.

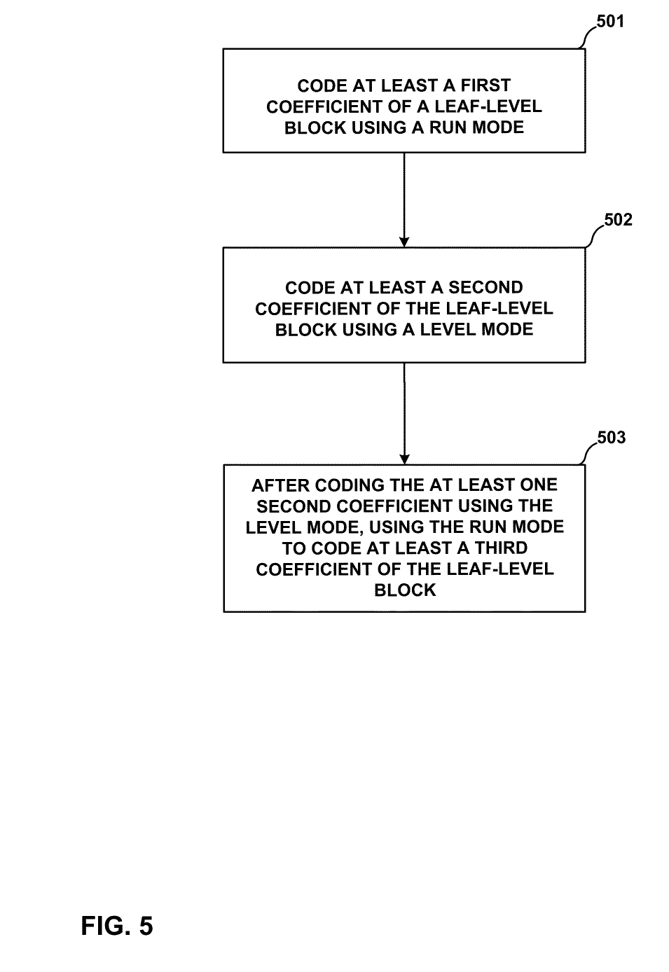

According to one aspect of this disclosure, encoder 20 is not only configured to transition from a run coding mode to a level coding mode while encoding a leaf-level unit, as described above with respect to other examples. Instead, encoder 20 is also configured to transition from the level coding mode to the run coding mode, as described in further detail below with respect to FIG. 5. To do so, encoder 20 may use one or more predetermined, signaled, or automatically determined thresholds, which may be specific to the level and run coding modes.

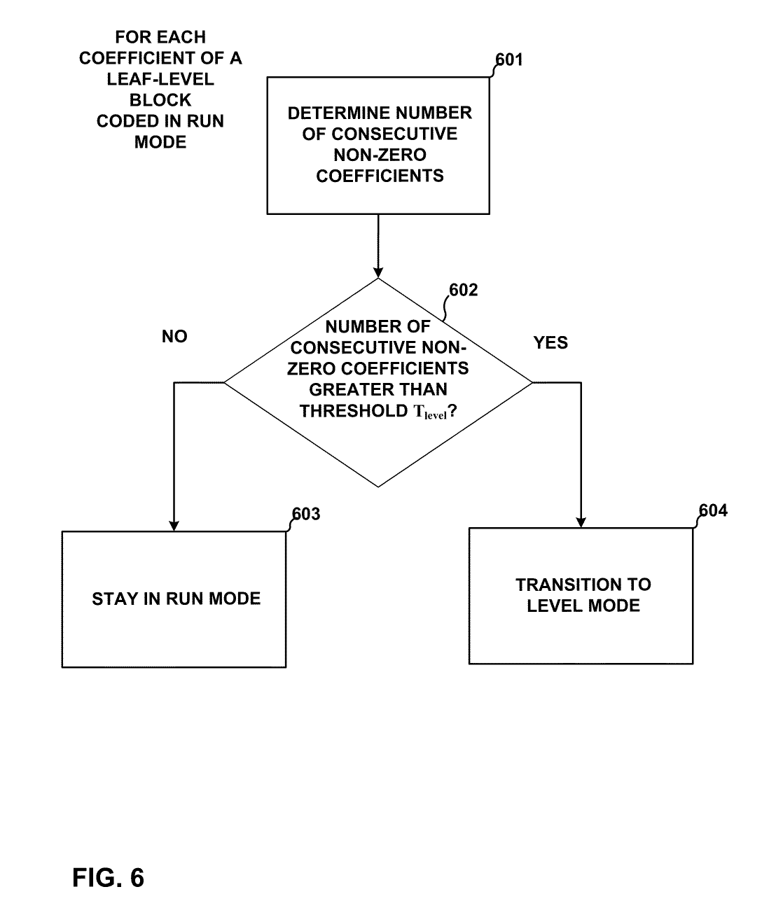

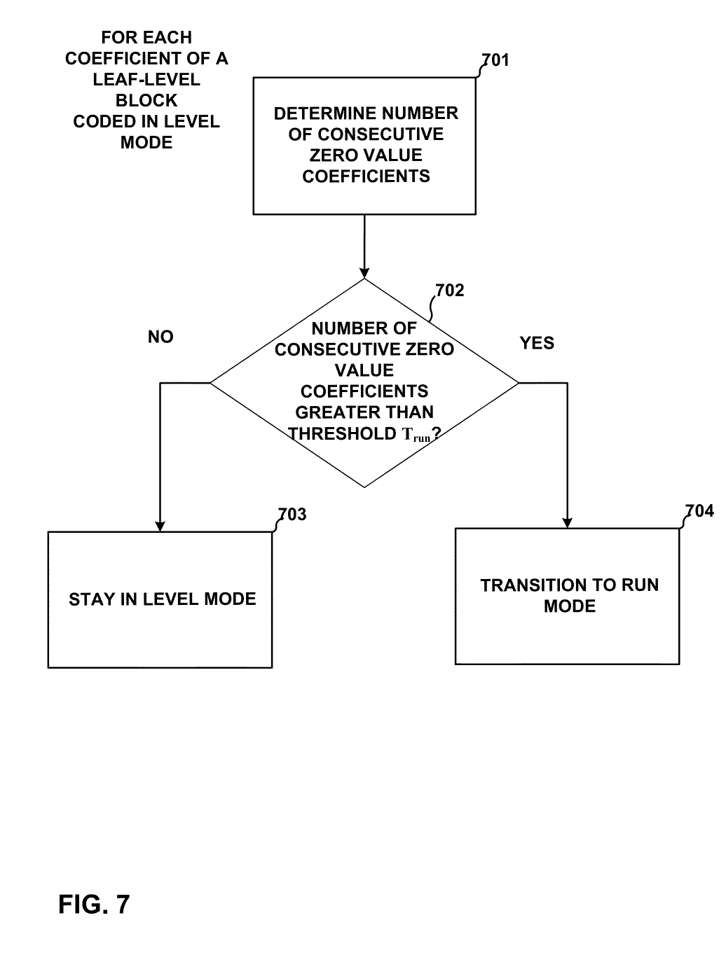

According to another aspect, encoder 20 may signal, to a decoder 30, an indication of a transition between the level and run coding modes (e.g., from level to run, or from run to level). According to these examples, encoder 20 generates an entropy encoded bit stream that includes one or more syntax elements that indicate when decoder 30 should transition from level to run, or from run to level, for a leaf-level unit of video data. For example, encoder 20 may signal, to decoder 30, one or more syntax elements that indicate one or more predetermined thresholds (that the decoder may use to transition between level and run, or between run and level. As one example, encoder 20 may generate a syntax element that indicates, to decoder 30, a value thresholds Th_num, Th_level as described herein, which may be used by encoder to transition from the run to the level coding mode. As another example, encoder 20 may generate a syntax element that indicates, to decoder 30, one or more of the Tᵣᵤₙ and Tₗₑᵥₑₗ thresholds described in further detail below with reference to FIGS. 6 and 7, which may be used by decoder 30 to transition between the level and run coding modes.

According to other aspects of this disclosure, encoder 20 automatically determines a transition between run and level coding modes (e.g., from run to level, or from level to run). As one such example, encoder 20 automatically determines the transition between run and level based on one or more characteristics of video data being coded

According to other examples, encoder 20 automatically determines when to transition between run and level coding modes as described herein based on one or more statistics regarding previously coded video data. For example, encoder 20 may be configured to automatically determine one or more threshold values (e.g., Th_num, Th_level and/or Tᵣᵤₙ and Tₗₑᵥₑₗ) that encoder 20 uses to transition between run and level coding modes, based on such statistics regarding previously coded coefficients.

Reciprocal transform coefficient decoding may also be performed by video decoder 30 of destination device 14. That is, video decoder 30 may map coefficients of a one-dimensional vector of transform coefficients that represent a block of video data to positions within a two-dimensional matrix of transform coefficients, to reconstruct the two-dimensional matrix of transform coefficients. For example, video decoder 30 may transition from a level coding mode to a run encoding mode, as described above with respect to encoder 20. According to another example, video decoder 30 may transition between the run and level coding modes based on one or more syntax elements read by the decoder as part of an entropy encoded bit stream. According to still another example, decoder 30 may automatically determine when to transition between run and level coding modes (or vice versa). For example, decoder 30 may automatically determine when to transition based on one or more characteristics of video data being coded and/or statistics regarding previously coded units video data.

The techniques described herein may improve an efficiency of video coding. For example, the techniques of this disclosure may enable decoder 30 to better adapt coding to local content and/or context of video data, which may improve coding efficiency.

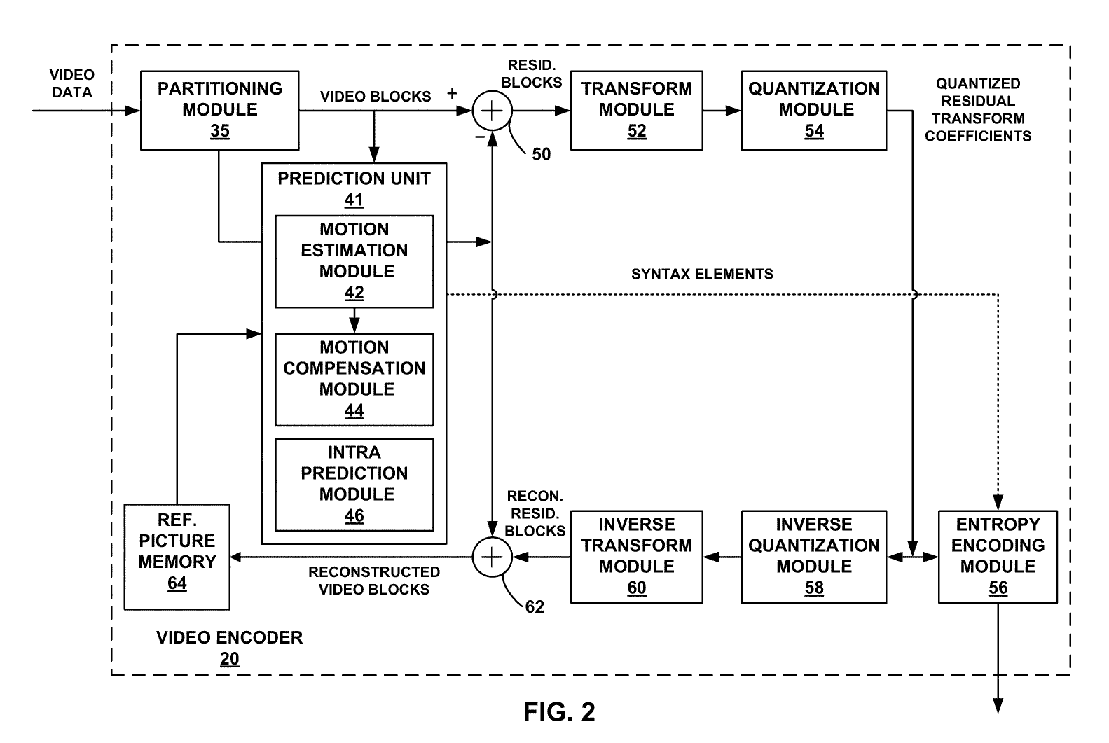

FIG. 2 is a block diagram illustrating an example video encoder 20 that may implement the inter-prediction techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 2, video encoder 20 includes a partitioning module 35, prediction module 41, reference picture memory 64, summer 50, transform module 52, quantization module 54, and entropy encoding module 56. Prediction module 41 includes motion estimation module 42, motion compensation module 44, and intra prediction module 46. For video block reconstruction, video encoder 20 also includes inverse quantization module 58, inverse transform module 60, and summer 62. A deblocking filter (not shown in FIG. 2) may also be included to filter block boundaries to remove blockiness artifacts from reconstructed video. If desired, the deblocking filter would typically filter the output of summer 62. Additional loop filters (in loop or post loop) may also be used in addition to the deblocking filter.

As shown in FIG. 2, video encoder 20 receives video data, and partitioning module 35 partitions the data into video blocks. This partitioning may also include partitioning into slices, tiles, or other larger units, as wells as video block partitioning, e.g., according to a quadtree structure of LCUs and CUs. Although partitioning module 34 is illustrated as a separate unit, the partitioning may actually be performed in conjunction with other coding steps, such as mode selection, motion estimation and motion compensation performed by prediction module 41. Video encoder 20 generally illustrates the components that encode video blocks within a video slice to be encoded. The slice may be divided into multiple video blocks (and possibly into sets of video blocks referred to as tiles). Prediction module 41 may select one of a plurality of possible coding modes, such as one of a plurality of intra coding modes or one of a plurality of inter coding modes, for the current video block based on error results (e.g., coding rate and the level of distortion). Prediction module 41 may provide the resulting intra- or inter-coded block to summer 50 to generate residual block data and to summer 62 to reconstruct the encoded block for use as a reference picture.

Intra prediction module 46 within prediction module 41 may perform intra-predictive coding of the current video block relative to one or more neighboring blocks in the same frame or slice as the current block to be coded to provide spatial compression. Motion estimation module 42 and motion compensation module 44 within prediction module 41 perform inter-predictive coding of the current video block relative to one or more predictive blocks in one or more reference pictures to provide temporal compression.

Motion estimation module 42 may be configured to determine the inter-prediction mode for a video slice according to a predetermined pattern for a video sequence. The predetermined pattern may designate video slices in the sequence as P slices, B slices or GPB slices. Motion estimation module 42 and motion compensation module 44 may be highly integrated, but are illustrated separately for conceptual purposes. Moreover, partitioning module 34 may also be highly integrated with motion estimation module 42 and motion compensation module 44. Motion estimation, performed by motion estimation module 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation module 42 may perform a motion search relative to the full pixel positions and fractional pixel positions and output a motion vector with fractional pixel precision.

Motion estimation module 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation module 42 sends the calculated motion vector to entropy encoding module 56 and motion compensation module 44.

Motion compensation, performed by motion compensation module 44, may involve fetching or generating the predictive block based on the motion vector determined by motion estimation, possibly performing interpolations to sub-pixel precision. Upon receiving the motion vector for the PU of the current video block, motion compensation module 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation module 44 may also generate syntax elements associated with the video blocks and the video slice for use by video decoder 30 in decoding the video blocks of the video slice.

After motion compensation module 44 generates the predictive block for the current video block, video encoder 20 forms a residual video block by subtracting the predictive block from the current video block. The residual video data in the residual block may be included in one or more TUs and applied to transform module 52. Transform module 52 transforms the residual video data into residual transform coefficients using a transform, such as a discrete cosine transform (DCT) or a conceptually similar transform. Transform module 52 may convert the residual video data from a pixel domain to a transform domain, such as a frequency domain.

Transform module 52 may send the resulting transform coefficients to quantization module 54. Quantization module 54 quantizes the transform coefficients to further reduce bit rate. The quantization process may reduce the bit depth associated with some or all of the coefficients. The degree of quantization may be modified by adjusting a quantization parameter.

Following quantization, entropy encoding module 56 entropy encodes the quantized transform coefficients. For example, entropy encoding module 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following entropy encoding, the encoded bitstream may be transmitted to video decoder 30, or archived for later transmission or retrieval by video decoder 30. Entropy encoding module 56 may also entropy encode the motion vectors and the other syntax elements for the current video slice being coded. In some examples, entropy encoding module 56 may then perform a scan of the matrix including the quantized transform coefficients to generate a one-dimensional vector of transform coefficients of an entropy encoded bit stream.

In some examples, coefficients of given leaf-level unit of a video frame may be ordered (scanned) according to a zigzag scanning technique, or a scanning technique that follows another pre-defined or adaptive scan order. Such a technique may be used by encoder 20 to generate a one-dimensional ordered coefficient vector. A zig-zag scanning technique may comprise beginning at an upper leftmost coefficient of the block, and proceeding to scan in a zig-zag pattern to the lower leftmost coefficient of the block.

According to a zigzag scanning technique, it may presumed that transform coefficients having a greatest energy (e.g., a greatest coefficient value) correspond to low frequency transform functions and may be located towards a top-left of a block. As such, for a coefficient vector (e.g., one-dimensional coefficient vector) produced based on zigzag scanning, higher magnitude coefficients may be assumed to most likely appear towards a start of the vector. It may also be assumed that, after a coefficient vector has been quantized, most low energy coefficients may be equal to 0. In some examples, coefficient scanning may be adapted during coefficient coding. For example a lower number in the scan may be assigned to positions for which non-zero coefficients happen more often.

According to some examples, encoder 20 may perform an inverse zig-zag scan of transform coefficients. According to an inverse zig-zag scan, encoder 20 begins encoding at a location that corresponds to a last non-zero coefficient (e.g., a non-zero coefficient furthest from an upper left position of the block). Unlike the example of a zig-zag scan described above, according to an inverse zig-zag scan, encoder 20 codes in a zigzag pattern from the last non-zero coefficient (i.e., in a bottom right position of the block) to an upper left position of the block.

According to a run encoding mode, if a coefficient has a magnitude greater than zero, encoder 20 may signal a level_ID syntax element for the scanned coefficient. The level_ID syntax element may indicate whether the coefficient has an amplitude of 1 or greater than 1. For example, encoder 20 may assign level_ID a value of zero (0) if the coefficient has a magnitude equal to one (1). However, if coefficient has a value greater than one (1), the encoder may assign level_ID a value of one (1). In some examples, if level_ID has a value of one, encoder 20 may also signal a level syntax element. The level syntax element may indicate a magnitude of the transform coefficient. For example, encoder 20 may assign the level syntax element a value of zero if the coefficient has a magnitude of two (2), a value of one if the coefficient has a magnitude of three (3), a value of two if the coefficient has a magnitude of four, and so on.

The run syntax element may indicate a number of coefficients with an amplitude close to or equal to zero between a current (encoded) coefficient and a next non-zero coefficient in the scanning order. According to one example, the run syntax element may have a value in a range from zero to k+1, where k is a position of the current non-zero coefficient. While decoding a transform coefficient, decoder 30 may use the run syntax element to determine a position of a next non-zero coefficient of the leaf-level unit, so that the decoder 30 may skip decoding zero-value coefficients in the run coding mode.

According to the level mode, encoder 20 signals a level syntax element, which indicates a magnitude of each transform coefficient. Decoder 30 may decode each coefficient scanned in level mode, regardless of whether the coefficient is non-zero. In some examples, both encoder 20 and decoder 30 may be configured to transition from the run coding mode to the level coding mode, based on at least one predetermined threshold stored in memory.

To begin coding a block of video data using the run coding mode, encoder 20 may first signal a last_pos syntax element, which indicates a position of a last non-zero coefficient (according to a zig-zag scan order, first coefficient of an inverse zig-zag scan order) of the scan. Encoder 20 may also signal a level_ID syntax element that indicates whether the last non-zero coefficient of the scan has a value of one (1) or greater than one, as described above. After encoder 20 has signaled the last_pos syntax element and the level_ID syntax element associated with the last_pos syntax element, encoder 20 may signal a run syntax element and a level_ID syntax element associated with one or more other coefficients of the scan.

According to some examples, encoder 20 may determine when to transition from the run coding mode to the level coding mode based on determined magnitudes for one or more already coded coefficients of the inverse zig-zag scan. For example, encoder 20 may transition from the run encoding mode to the level coding mode based on predetermined Th_level and Th_num thresholds stored in memory, which may be based on a size of a coding unit being coded. The predetermined threshold Th_level may indicate a transform coefficient magnitude, and the threshold Th_num may indicate a number of coded coefficients with a magnitude greater than the threshold Th_level. According to these examples, encoder 20 may count a number N of previously coded transform coefficients with a value greater than a predetermined threshold Th_level. If the counted number N is greater than a predetermined threshold Th_num, encoder 20 transitions from the run coding mode to the level coding mode. Encoder 20 then continues to use the level coding mode to encode the remaining transform coefficients of the leaf-level unit. In this manner, encoder 20 determines when to transition from the run coding mode to the level coding mode, based on a magnitude of previously coded coefficients of the leaf-level unit.

This disclosure is directed to techniques for switching between a run coding mode and a level coding mode while coding a leaf-level unit of transform coefficients. The techniques described herein may enable an encoder to code the transform coefficients with improved efficiency in comparison to other techniques. Although the techniques are described with respect to an inverse zig-zag scan order, the techniques may be useful with any scan order including any combination of horizontal scans, vertical scans, non-inverse zig-zag scan, or even adaptively-defined or adjustable scans.

As described above, in some examples, encoder 20 may be configured to begin coding transform coefficient of a leaf-level unit using a run encoding mode, and transition to coding other coefficients of the block in a level coding mode, based on the magnitudes of one or more previously coded coefficients of the leaf-level unit. In some examples, only switching from the run coding mode to the level coding mode may cause inefficiencies in coding. For example, “false” (e.g., inaccurate) determination that encoder 20 should switch from the run coding mode to the level coding mode may cause coding inefficiencies. Furthermore, according to these examples, one or more thresholds (e.g., Th_level, Th_num described above) that may be used by encoder 20 to determine when to transition from the run coding mode to the level coding mode may be dependent only on a size of a block of video data being coded. In some examples, using such a predetermined threshold defined based on a size of a block being coded may not be able to adapt well to local content and/or context of video data being coded, which may therefore limit coding efficiency.

According to some aspects of this disclosure, encoder 20 may be configured to transition back and forth between using level and run coding modes to code transform coefficients of a leaf-level unit. For example, according to these techniques, encoder 20 may begin coding transform coefficients of the leaf-level unit using a run encoding mode. As encoder 20 codes transform coefficients in the run coding mode, if encoder 20 determines that a number of consecutive non-zero coefficients of the scan is greater than a threshold Tₗₑᵥₑₗ encoder 20 transitions to the level mode for at least one subsequent coefficient of the scan. Also according to this example, when encoder 20 is coding transform coefficients using the level coding mode, if encoder 20 determines that a number of consecutive coefficients that have a magnitude equal to zero are greater than a threshold Tᵣᵤₙ, the coder transitions to using the run encoding mode for at least one subsequent coefficient of the scan. According to these examples, encoder 20 may transition back and forth between the level and run encoding modes, which may improve an ability of encoder 20 to adapt encoding to local content and/or context of video data being coded in comparison to other techniques, such as where encoder 20 only transitions from the run coding mode to the level coding mode while performing a scan of transform coefficients, as described above.

According to other aspects of this disclosure, encoder 20 may signal, to a decoder 30, an indication that may be used by decoder 30 to transition from using a run coding mode to using a level coding mode to code transform coefficients (and/or to transition from a level coding mode to a run coding mode). For example, the encoder 20 may generate one or more syntax elements that may be used by decoder 30 to define when to switch between the respective run and level coding modes. For example, encoder 20 may generate one or more syntax element that indicate one or more thresholds, such as Th_num, Th_level, and/or Tᵣᵤₙ, Tₗₑᵥₑₗ thresholds described above, which may be used by decoder 30 to transition between level and run coding modes (e.g., from level to run, or from run to level). Decoder 30 may use such syntax elements to determine when to transition from using the run coding mode to using the level coding mode and/or from the level coding mode to the run coding mode.

In some examples, encoder 20 may generate such a syntax element associated with a larger unit of video data, such as a frame, slice, LCU, or other divisible unit of video data. According to these examples, decoder 30 may use the syntax element and apply it to a plurality of sub-units (e.g., leaf-level units) within the larger video unit of video data. A value of the syntax element may differ for different units of video data. In other examples, encoder 20 may generate such a syntax element that is associated with one or more smaller units of video data, such as a leaf-level (e.g., undivided) unit of video data. Such a leaf-level unit specific syntax element may differ for different units of video data. In some examples, encoder 20 may signal such one or more syntax elements as part of header information associated with a picture (frame) of video data (e.g., a picture parameter set (PPS)), and/or associated with a sequence of pictures (frames) of video data (e.g., a sequence parameter set (SPS)).

In some examples, an encoder 20 configured to generate a syntax element that indicates to decoder 30 when to transition between level and run coding modes as described above may enable the encoder 20 to better control operation of decoder 30 to decode video data, which may improve coding efficiency.

According to other aspects of this disclosure, encoder 20 may automatically determine when to transition between run and level coding modes. For example, encoder 20 may automatically determine one or more threshold values (e.g., Th_num, Th_level and/or Tᵣᵤₙ, Tₗₑᵥₑₗ) that encoder 20 may use to transition between run and level coding modes.

According to one such example, encoder 20 automatically determines one or more threshold values based on one or more characteristics of video data being coded, and uses the automatically determined threshold to transition between level and run coding modes. For example, encoder 20 may determine the one or more thresholds based on one or more characteristics of video data such as prediction type (intra or inter-prediction) o, a type of color component (e.g., luma or chroma), a motion partition (e.g., (2N×N, N×2N or 2N×2N), a size of a motion partition, a size of a transform block, one or more quantization parameters, an amplitude of one or more motion vectors, and/or one or more motion vector predictions, of the frame or block.

According to another example, encoder 20 may, also or instead, automatically determine such one or more threshold values based on one or more statistics regarding at least one previously coded frame or unit of video data. For example, encoder 20 may automatically determine a threshold value (e.g., Th_num, Th_level and/or Tᵣᵤₙ, Tₗₑᵥₑₗ) based on one or more statistics regarding previously decoded video data.

As an example, encoder 20 may be configured to maintain one or more counters that encoder 20 updates each time a coding unit of video data is decoded. According to these examples, each time encoder 20 encodes a unit of video data, encoder 20 may determines a value reflected by the counters, and define when to transition between level and run coding modes based on the determined value. In some examples, encoder 20 may use such counters that count more general statistics regarding a unit of video data, such as a percentage of non-zero coefficients in a frame, slice, LCU, TU, PU, or other coding unit. According to other examples, encoder 20 may use more specific counters that count how often coefficients a particular positions within a decoded unit of video data are non-zero. According to still other examples, encoder 20 may use counters that are specific to a coding mode used to code each coefficient. For example, encoder 20 may maintain a first counter that counts a percentage of non-zero coefficients decoded in the run coding mode, and a second counter that counts a percentage of non-zero coefficients decoded in the level coding mode.

As one specific example, encoder 20 may automatically determine the threshold values Th_num based on one or more statistics. For example, while the decoder is decoding units of video data, if previously coded video data has a relatively high percentage of non-zero coefficients, encoder 20 decreases the threshold Th_num which causes encoder 20 to transition from the run coding mode to the level coding mode earlier than for previously decoded unit. Also according to this example, if previously coded video data has a relatively low percentage of non-zero coefficients, encoder 20 increases the threshold Th_num which causes encoder 20 to transition from the run coding mode to the level coding mode later than for previously decoded video data.

According to the techniques described above, encoder 20 may automatically determine when to transition between level and run coding modes based on one or more characteristics of video data and/or statistics regarding previously coded video data. In some example, automatically determining when to transition between the level and run coding modes as described above may enable encoder 20 to adapt coding to local content and/or context of video data being coded without generating one or more syntax elements from an entropy encoded bit stream, which may thereby improve coding efficiency of encoder 20.

Inverse quantization module 58 and inverse transform module 60 apply inverse quantization and inverse transformation, respectively, to reconstruct the residual block in the pixel domain for later use as a reference block of a reference picture. Motion compensation module 44 may calculate a reference block by adding the residual block to a predictive block of one of the reference pictures within one of the reference picture lists. Motion compensation module 44 may also apply one or more interpolation filters to the reconstructed residual block to calculate sub-integer pixel values for use in motion estimation. Summer 62 adds the reconstructed residual block to the motion compensated prediction block produced by motion compensation module 44 to produce a reference block for storage in reference picture memory 64. The reference block may be used by motion estimation module 42 and motion compensation module 44 as a reference block to inter-predict a block in a subsequent video frame or picture.

Above, the techniques of this disclosure are described as being performed by an encoder 20. The techniques described herein may also be performed is a reciprocal manner by a decoder 30. For example, encoder 20 may use one or more of the techniques described above to determine when to transition between run and level coding modes to encode transform coefficients of a block of video data. Encoder 20 may, for example, transition between the run and level coding modes using one or more of the techniques described above to scan a plurality of transform coefficients of a two-dimensional matrix of transform coefficients, to generate a one-dimensional vector of transform coefficients as part of an entropy encoded bit stream. Decoder 30 may use the techniques described herein to transition between run and level coding modes as described above to decode a plurality of transform coefficients of a block of video data. For example, decoder 30 may transition between the run and level coding modes to map a one-dimensional vector of transform coefficients (e.g., of an entropy encoded bit stream), to reconstruct a two-dimensional matrix of transform coefficients.

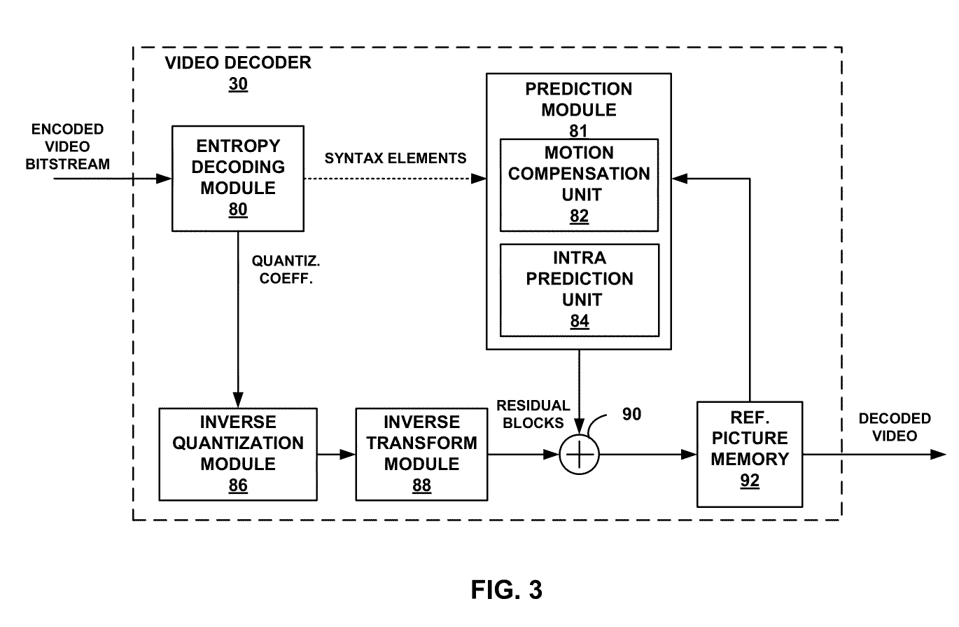

FIG. 3 is a block diagram that illustrates one example of video decoder 30 that may implement the inter-prediction techniques described in this disclosure. In the example of FIG. 3, video decoder 30 includes an entropy decoding module 80, prediction module 81, inverse quantization module 86, inverse transformation module 88, summer 90, and reference picture memory 92. Prediction module 81 includes motion compensation module 82 and intra prediction module 84. Video decoder 30 may, in some examples, perform a decoding pass generally reciprocal to the encoding pass described with respect to video encoder 20 from FIG. 2.

During the decoding process, video decoder 30 receives an encoded video bitstream that represents video blocks of an encoded video slice and associated syntax elements from video encoder 20. Entropy decoding module 80 of video decoder 30 entropy decodes the bitstream to generate quantized coefficients, motion vectors, and other syntax elements. Entropy decoding module 80 forwards the motion vectors and other syntax elements to prediction module 81. Video decoder 30 may receive the syntax elements at the video slice level and/or the video block level. Entropy decoding module 80 may read a one-dimensional vector of transform coefficients decoded by entropy decoding module, and reconstruct a two-dimensional matrix of transform coefficients from the one-dimensional vector.

This disclosure is directed to techniques for switching between a run coding mode and a level coding mode while coding a leaf-level unit of transform coefficients. The techniques described herein may enable a decoder to code the transform coefficients of a leaf-level unit with improved efficiency in comparison to other techniques.

As described above, in some examples, decoder 30 may be configured to begin mapping transform coefficient of a leaf-level unit to positions within a two-dimensional matrix using a run encoding mode, and transition to coding the remaining coefficients of the leaf-level unit in a level coding mode, based on the magnitudes of one or more previously coded coefficients. In some examples, only switching from the run coding mode to the level coding mode may cause inefficiencies in coding. For example, “false” (e.g., inaccurate) determination that decoder 30 should switch from the run coding mode to the level coding mode may cause coding inefficiencies. Furthermore, according to these examples, one or more thresholds (e.g., Th_level, Th_num described above) that may be used by decoder 30 to determine when to transition from the run coding mode to the level coding mode may be dependent only on a size of a block of video data being coded. In some examples, using such a predetermined threshold defined based on a size of a block being coded may not be able to adapt well to local characteristics of video data, and may therefore limit coding efficiency.

According to some aspects of this disclosure, decoder 30 may transition back and forth between using level and run coding modes to code transform coefficients of a leaf-level unit. For example, decoder 30 may begin mapping transform coefficients of the leaf-level unit using a run encoding mode. As decoder 30 maps transform coefficients in the run coding mode, if decoder 30 determines that a predetermined number of consecutive coefficients of the scan have a magnitude greater than zero (a non-zero coefficient), decoder 30 may transition from the run coding mode to the level coding mode. While coding transform coefficients using the level coding mode, if decoder 30 determines that a predetermined number of consecutive coefficients have a magnitude equal to zero, the coder may transition back to using the run encoding mode for at least one further coefficient of the scan. In this manner, decoder 30 may transition back and forth between the level and run encoding modes, which may improve the efficiency of decoder 30 to code transform coefficients.

In some examples, decoder 30 may transition between using level and run coding modes as described above based on at least one threshold. For example, a first threshold, Tₗₑᵥₑₗ may be used to transition from the run coding mode to the level coding mode. According to this example, the first threshold Tₗₑᵥₑₗ indicates a number of consecutive non-zero coefficients. If decoder 30 decodes the number of consecutive non-zero coefficients indicated by the threshold Tₗₑᵥₑₗ, decoder 30 transitions from the run coding mode to the level encoding mode.

According to another example, decoder 30 may, also or instead, use a second threshold Tᵣᵤₙ to transition from the level coding mode to the run coding mode. According to this example, the second threshold indicates a number of consecutive zero-valued coefficients. If decoder 30 decodes the number of consecutive zero-valued coefficients indicated by the threshold Tᵣᵤₙ, decoder 30 transitions from the level coding mode to the run coding mode.

According to other aspects of this disclosure, decoder 30 may transition between run and level coding modes based on an indication received from encoder 20. For example, according to this aspect, encoder 20 generates, as part of an entropy encoded bit stream, one or more syntax elements that may be used by decoder 30 to determine when to switch between the respective run and level coding modes. As one example, decoder 30 may read one or more syntax elements that indicate one or more thresholds, that decoder uses to transition from run to level, such as the Th_num and/or Th_level thresholds described above. As another example, decoder 30 may read one or more syntax elements that indicate one or more thresholds that decoder 30 uses to transition from run to level or level to run, such as the Tᵣᵤₙ and Tₗₑᵥₑₗ syntax elements described above. According to these examples, decoder 30 may use the one or more signaled thresholds to determine when to transition from using the run coding mode to using the level coding mode (and/or vice versa). In some examples, decoder 30 may read such one or more syntax elements as part of header information if a bit stream that is associated with a picture (frame) of video data (e.g., a picture parameter set (PPS)), and/or associated with a sequence of pictures (frames) of video data (e.g., a sequence parameter set (SPS)).

In some examples, decoder 30 may read such one or more syntax elements that a decoder 30 may use to transition between run and level coding modes (and/or vice versa) that are associated with one or more frames of a video sequence. For example, for one or more frames of a video sequence, decoder may signal such one or more syntax elements (e.g., Th_num, Th_level and/or Tᵣᵤₙ, Tₗₑᵥₑₗ) that may be used by the decoder 30 to transition between the run and level coding modes for the one or more frames (e.g., for coding units of the one or more frames). In some examples, such frame-specific syntax elements may be different for different encoded frames of a video sequence.

According to other examples, decoder 30 may read such one or more syntax elements that decoder 30 uses to transition from the run coding mode to the level coding mode (and/or vice versa) specific to one or more leaf-level coding units of video data. For example, decoder 30 may read such one or more syntax elements (e.g., Th_num, Th_level and/or Tᵣᵤₙ, Tₗₑᵥₑₗ) associated with a leaf-level unit, and use the read syntax element to transition between the run and level coding modes when decoding the leaf-level unit. In some examples, such leaf-level unit specific syntax elements may different for different encoded units of video data.

According to other aspects of this disclosure, decoder 30 may automatically determine when to transition between run and level coding modes as described herein. For example, decoder 30 may be configured to automatically determine one or more threshold values (e.g., Th_num, Th_level and/or Tᵣᵤₙ, Tₗₑᵥₑₗ) that decoder 30 may use to transition between run and level coding modes.

According to one such example, decoder 30 may automatically determine such a threshold value based on one or more characteristics of a block or frame of video data being coded. For example, decoder 30 may determine the threshold based on one or more characteristics of video data, such as prediction type (intra or inter-prediction) o, a type of color component (e.g., luma or chroma), a motion partition (e.g., (2N×N, N×2N or 2N×2N), a size of a motion partition, a size of a transform block, one or more quantization parameters, an amplitude of one or more motion vectors, and/or one or more motion vector predictions, of the video data (e.g., of a frame, slice, larger block (e.g., LCU), smaller block (e.g., leaf-level unit, TU).

According to another example, decoder 30 may, also or instead, automatically determine such one or more threshold values based on one or more statistics regarding at least one previously coded frame or unit of video data. For example, decoder 30 may automatically determine a threshold value (e.g., Th_num, Th_level and/or Tᵣᵤₙ, Tₗₑᵥₑₗ) based on one or more statistics regarding previously decoded video data.

As an example, decoder 30 may be configured to maintain one or more counters that decoder 30 updates each time a coding unit of video data is decoded. According to these examples, each time decoder 30 decodes a unit of video data, decoder 30 may determines a value reflected by the counters, and define when to transition between level and run coding modes based on the determined value. In some examples, decoder 30 may use such counters that count more general statistics regarding a unit of video data, such as a percentage of non-zero coefficients in a frame, slice, LCU, TU, PU, or other coding unit. According to other examples, decoder 30 may use more specific counters that count how often coefficients a particular positions within a decoded unit of video data are non-zero. According to still other examples, decoder 30 may use counters that are specific to a coding mode used to code each coefficient. For example, decoder 30 may maintain a first counter that counts a percentage of non-zero coefficients decoded in the run coding mode, and a second counter that counts a percentage of non-zero coefficients decoded in the level coding mode.

As one specific example, decoder 30 may automatically determine the threshold value Th_num based on one or more statistics. For example, while the decoder is decoding units of video data, if previously coded video data includes a relatively high percentage of non-zero coefficients, decoder 30 decreases the threshold Th_num which causes decoder 30 to transition from the run coding mode to the level coding mode earlier than for previously decoded unit. Also according to this example, if previously coded video data includes a relatively low percentage of non-zero coefficients, decoder 30 increases the threshold Th_num which causes decoder 30 to transition from the run coding mode to the level coding mode later than for previously decoded video data.

According to the techniques described above, decoder 30 may automatically determine when to transition between level and run coding modes based on one or more characteristics of video data and/or statistics regarding previously coded video data. In some example, automatically determining when to transition between the level and run coding modes, as described above, may enable decoder 30 to better adapt decoding to local content and/or context of video data being coded without reading one or more syntax elements from an entropy encoded bit stream, which may thereby improve coding efficiency of decoder 30.

When a video slice is coded as an intra-coded (I) slice, intra prediction module 84 of prediction module 81 may generate prediction data for a video block of the current video slice based on a signaled intra prediction mode and data from previously decoded blocks of the current frame or picture. When the video frame is coded as an inter-coded (i.e., B, P or GPB) slice, motion compensation module 82 of prediction module 81 produces predictive blocks for a video block of the current video slice based on the motion vectors and other syntax elements received from entropy decoding module 80. The predictive blocks may be produced from one of the reference pictures within one of the reference picture lists. Video decoder 30 may construct the reference frame lists, List 0 and List 1, using default construction techniques based on reference pictures stored in reference picture memory 92.

Motion compensation module 82 determines prediction information for a video block of the current video slice by parsing the motion vectors and other syntax elements, and uses the prediction information to produce the predictive blocks for the current video block being decoded. For example, motion compensation module 82 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation module 82 may also perform interpolation based on interpolation filters. Motion compensation module 82 may use interpolation filters as used by video encoder 20 during encoding of the video blocks to calculate interpolated values for sub-integer pixels of reference blocks. In this case, motion compensation module 82 may determine the interpolation filters used by video encoder 20 from the received syntax elements and use the interpolation filters to produce predictive blocks.

Inverse quantization module 86 inverse quantizes, i.e., de-quantizes, the quantized transform coefficients provided in the bitstream and decoded by entropy decoding module 80.

In some examples, the inverse quantization process may include use of a quantization parameter calculated by video encoder 20 for each video block in the video slice to determine a degree of quantization and, likewise, a degree of inverse quantization that should be applied. Inverse transform module 88 applies an inverse transform, e.g., an inverse DCT, an inverse integer transform, or a conceptually similar inverse transform process, to the transform coefficients in order to produce residual blocks in the pixel domain.

After motion compensation module 82 generates the predictive block for the current video block based on the motion vectors and other syntax elements, video decoder 30 forms a decoded video block by summing the residual blocks from inverse transform module 88 with the corresponding predictive blocks generated by motion compensation module 82. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference picture memory 92 also stores decoded video for later presentation on a display device, such as display device 32 of FIG. 1.

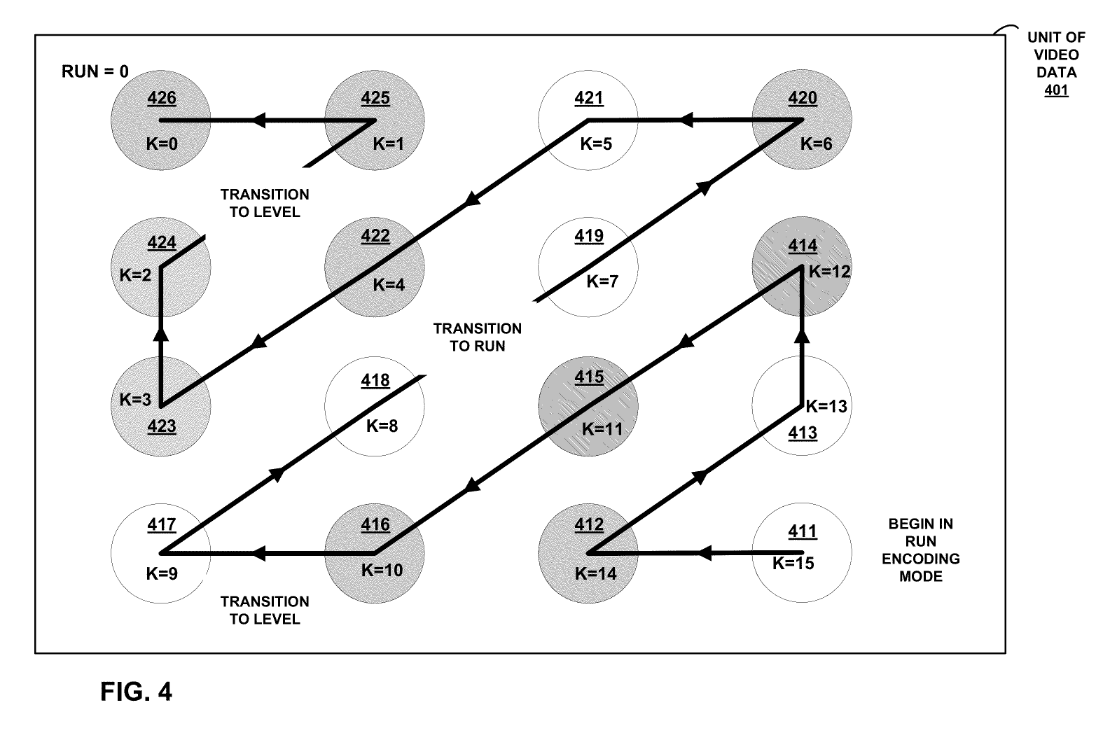

FIG. 4 is a conceptual diagram that depicts one example of a scan of transform coefficients of a leaf-level unit 401 of video data consistent with one or more aspects of this disclosure. The techniques of FIG. 4 are described as performed by encoder 20 depicted in FIGS. 1 and 2, however any device, such as decoder 30 depicted in FIGS. 1 and 3, may be used to perform the techniques of FIG. 4.

As shown in FIG. 4, leaf-level unit 401 includes a plurality of transform coefficients 411-426 that are each arranged at positions in a two-dimensional matrix. According to the example of FIG. 4, leaf-level unit 401 may comprise any arrangement of video data for which video encoder 20 performs a scan of transform coefficients. For example, leaf-level unit 401 may comprise an undivided coding unit, such as a transform leaf-node transform unit (TU) as described above.

The example of FIG. 4 shows an inverse zig-zag scan of a leaf-level coding unit 401 that includes sixteen transform coefficients (e.g., a 4×4 coding unit). According to other examples, encoder 20 may apply the techniques described herein to larger, or smaller, coding units. In addition, although FIG. 4 depicts an inverse zig-zag scan of transform coefficients, the techniques described herein may be useful with any scan order including any combination of horizontal scans, vertical scans, non-inverse zig-zag scan, or even adaptively-defined or adjustable scans.

According to the techniques described herein, encoder 20 begins coding transform coefficients of leaf-level unit 401 at a last non-zero coefficient 412 of coding unit 401 according to the inverse zig-zag scan. The last non-zero coefficient of coding unit 401 may be described as a first coefficient of the inverse zig-zag scan that has a magnitude greater than zero.

According to the example of FIG. 4, after coding coefficient 412 encoder 20 generates a run syntax element that indicates how many zero value coefficients (one, coefficient 413 in the example of FIG. 4) are between coefficient 412 and a next non-zero coefficient (coefficient 414 in the example of FIG. 4) in the order of the scan. In the run mode, encoder 20 also generates a level_ID syntax element that indicates whether the coefficient has a value of 1, or greater than one, as described above.

According to some examples of encoding techniques, encoder 20 then continues to encode some transform coefficients of coding unit 20 in the run mode, until encoder 20 determines to transition to a level coding mode based on at least one predetermined threshold stored in memory. According to these examples, encoder 20 reads the predetermined thresholds Th_num, Th_level from memory, and determines based on the thresholds when to transition from the run coding mode to the level coding mode based on the threshold. In the level coding mode, encoder 20 generates a level syntax element that indicates a magnitude of each coefficient, as opposed to the run and level_ID syntax elements generated in the run mode for each coefficient. According to these examples, once encoder 20 has transitioned to encoding transform coefficients in the level mode, encoder 20 encodes the remaining coefficients of the leaf-level unit in the level coding mode.

According some aspects of this disclosure, encoder 20 may, in addition to transitioning from the run coding mode to the level coding mode as described above, transition from a level coding mode to a run coding mode. In this manner, encoder 20 may transition between the level and run coding modes. In some examples, encoder 20 may transition from the level coding mode to the run coding mode based on at least one threshold.

For example, encoder 20 may have access to a first threshold Tₗₑᵥₑₗ, which indicates when encoder 20 should transition from the run coding mode to the level coding mode. For example, the first threshold Tₗₑᵥₑₗ may indicate a number of consecutive zero value coefficients of a scan. According to this example, if encoder 20 encodes a number of consecutive non-zero coefficients greater than the threshold Tₗₑᵥₑₗ while in the run coding mode, encoder 20 transitions from the run coding mode to the level coding mode.

Encoder 20 may also, or instead, have access to a second threshold Tᵣᵤₙ, which indicates when encoder 20 should transition from the level coding mode to the run coding mode. For example, the second threshold Tᵣᵤₙ may indicate a number of consecutive zero value coefficients of a scan. According to this example, if encoder 20 encodes a number of consecutive non-zero coefficients greater than the threshold Tᵣᵤₙ while in the level coding mode, encoder may transition to coding subsequent coefficients in the run coding mode.

Referring back to the example of FIG. 4, the shaded coefficients 412, 414-416, 420, and 422-426 comprise non-zero coefficients, while the non-shaded coefficients 411, 413, 417-419, and 421. According to the example of FIG. 4, the threshold Tₗₑᵥₑₗ may have a value of 2, and the threshold Tᵣᵤₙ has a value of 1. As shown in FIG. 4, encoder begins coding coefficient 412 (the last non-zero coefficient of coding unit 401), and after coding coefficient 412 encoder generates the level_ID and run syntax elements described above. Encoder 20 continues to encode coefficients 414, 415, and 416 using the run mode, generating the level_ID and run syntax elements for each coefficient. Consecutive coefficients 414, 415, and 416 each comprise non-zero coefficients, which is greater than the threshold value Tₗₑᵥₑₗ of 2. As shown in FIG. 4, because encoder 20 has encoded a number of consecutive non-zero coefficients greater than the threshold value Tₗₑᵥₑₗ, encoder 20 transitions from the run coding mode to the level coding mode.

According to this example, encoder 20 continues to code coefficients 417 and 418 in the level mode. Consecutive coefficients 417 and 418 each comprise zero value coefficients, which is greater than the threshold Tᵣᵤₙ value of 1. As shown in FIG. 4, because encoder 20 has encoded a number of consecutive zero value coefficients greater than the threshold value Tᵣᵤₙ, encoder 20 transitions from the level coding mode to the run coding mode. Encoder 20 may then proceed to encode coefficients 419, 420, 421, 422, and 423 in the run coding mode. Consecutive coefficients 422, 423, and 425 each comprise non-zero coefficients, which is greater than the threshold value Tₗₑᵥₑₗ of 2. As shown in FIG. 4, because encoder 20 has encoded a number of consecutive non-zero coefficients greater than the threshold value Tₗₑᵥₑₗ, encoder 20 transitions from the run coding mode to the level coding mode for the remaining coefficients 425 and 426 of the scan.

The example of FIG. 4 is described as being performed by encoder 20, which may apply the techniques of this disclosure to scan a two-dimensional matrix of transform coefficients that represent a coding unit of video data to generate a one-dimensional vector of transform coefficients that represent the coding unit. Reciprocal techniques may also be performed by decoder 30, to reconstruct the two-dimensional matrix of transform coefficients from the one-dimensional vector. For example, decoder 30 may, while mapping coefficients of the one-dimensional vector to positions within the two-dimensional matrix, transition between level and run coding modes based on one or more threshold values (e.g., Tₗₑᵥₑₗ and Tᵣᵤₙ described above), to reconstruct the two-dimensional matrix.

FIG. 5 is a flow diagram that illustrates one example of a method that may be performed by a coder to code a leaf-level unit of transform coefficients consistent with one or more aspects of this disclosure. The method of FIG. 5 is described as being performed by encoder 20 below, however any device, including decoder 30 depicted in FIG. 3, may be used to perform the technique of FIG. 5.

According the method of FIG. 5, encoder 20 (e.g., entropy encoding module 56 depicted in FIG. 2) codes a first at least one coefficient of a leaf-level unit of video data using a run coding mode (501). As described above, according to the run coding mode, encoder 20 generates a run syntax element and a level_ID syntax element associated with each coefficient coded in the run coding mode.

As also shown in FIG. 5, encoder 20 codes a second at least one coefficient of the leaf-level unit using a level coding mode (502). According to the level coding mode, encoder 20 generates a level syntax element associated the second at least one coefficient, instead of the run and level_ID syntax elements generated during the run coding mode.

As also shown in FIG. 5, after encoder 20 encodes the second coefficient, encoder 20 transitions from the level coding mode back to the run coding mode to encode a third at least one coefficient of the leaf-level unit of video data (503). In this manner, encoder 20 may transition between using run and level encoding modes to encode the unit of video data.

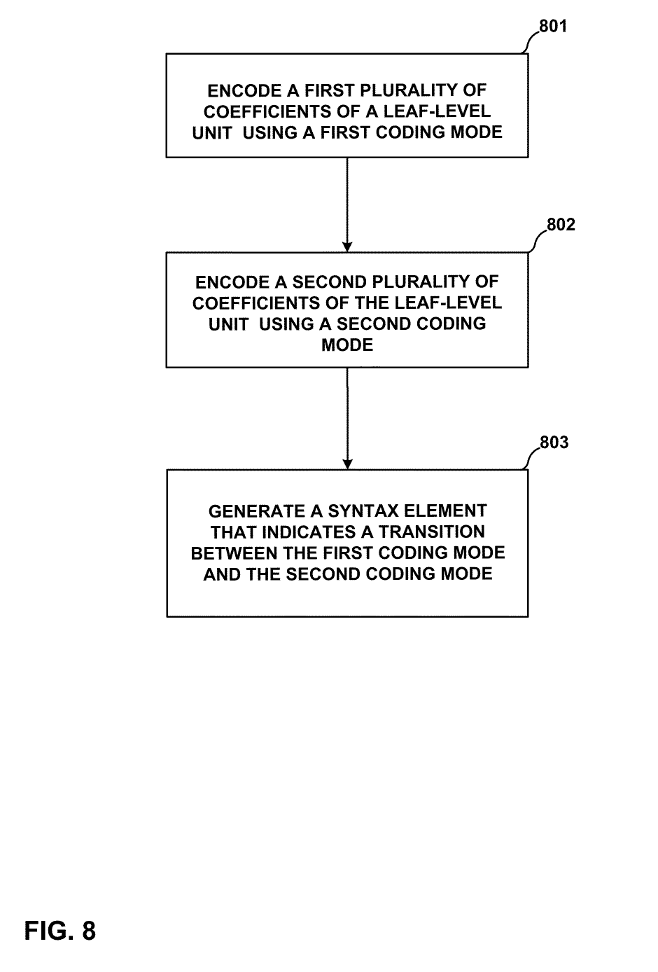

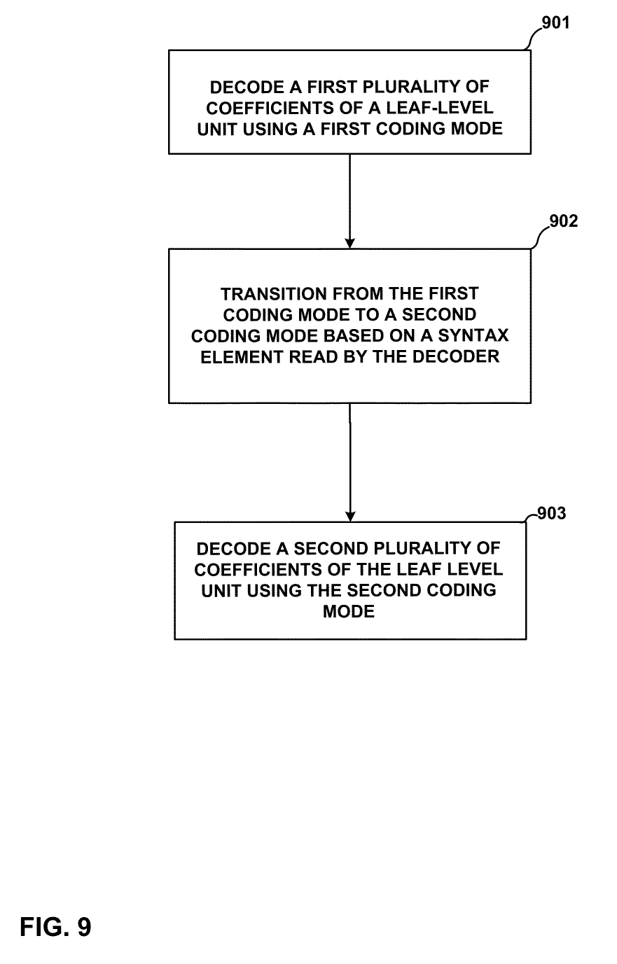

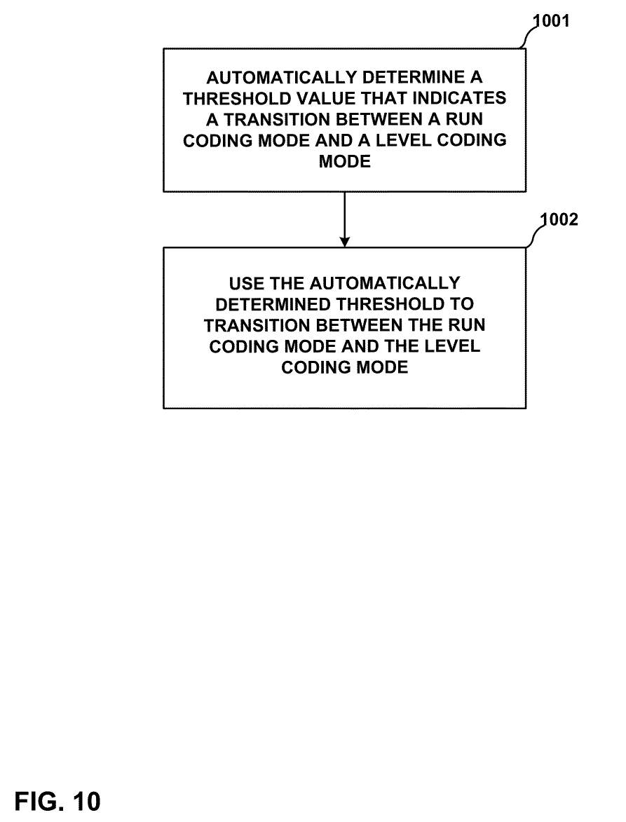

In some examples, encoder 20 determines when to transition between the run and level encoding modes based on at least one threshold. For example, encoder 20 may use a first threshold Tₗₑᵥₑₗ to determine when to transition from using the run coding mode to the level coding mode, as described in further detail below with reference to FIG. 6. Also according to this example, encoder 20 may use a second threshold Tᵣᵤₙ to determine when to transition from using the level coding mode to using the run coding mode as described in further detail below with reference to FIG. 7. In some examples, the thresholds Tᵣᵤₙ and Tₗₑᵥₑₗ may be predetermined thresholds stored in a memory accessible by encoder 20 and decoder 30. In other example, the thresholds Tᵣᵤₙ and Tₗₑᵥₑₗ may be generated by encoder 20 to decoder 30 as syntax elements of an entropy encoded bit stream, as described in further detail below with reference to FIGS. 8 and 9. In still other examples, the thresholds Tᵣᵤₙ and Tₗₑᵥₑₗ may be automatically determined by encoder 20 and/or decoder 30, as described in further detail below with reference to FIG. 10. For example, encoder 20 and/or decoder 30 may automatically determine the thresholds Tᵣᵤₙ and Tₗₑᵥₑₗ based on one or more characteristics of the video data being coded, and/or based on one or more collected statistics regarding previously coded video data, as also described in further detail below.

FIG. 6 is a flow diagram that illustrates one example of a method that may be performed by a coder to transition from using a run coding mode to using a level coding mode consistent with one or more aspects of this disclosure. The method of FIG. 6 is described as being performed by encoder 20 below, however any device, including decoder 30 depicted in FIG. 3, may be used to perform the technique of FIG. 6.

According to the example of FIG. 6, encoder 20 is operated in a run coding mode to scan one or more transform coefficients of a unit of video data. For coefficients that are encoded in the run coding mode, encoder 20 generates run and level_ID syntax elements as described above. As shown in FIG. 6, for each coefficient coded in the run mode, encoder 20 (e.g., entropy encoding module 56 depicted in FIG. 2) determines a number of consecutive coefficients of a scan order (e.g., an inverse zig-zag scan as depicted in FIG. 4, or any other predetermined or adaptive scan order) with a non-zero magnitude (i.e., a magnitude of one or greater than one) encoded by encoder 20 (601). As also shown in FIG. 6, encoder 20 compares the determine number of consecutive non-zero coefficients to a threshold Tₗₑᵥₑₗ (602). As also shown in FIG. 6, if encoder 20 determines that the number of consecutive non-zero coefficients is less than or equal to a value of the threshold Tₗₑᵥₑₗ, encoder 20 uses a run coding mode to encode a subsequent coefficient of the scan of the leaf-level unit (603). However, if encoder 20 determines that the number of consecutive non-zero coefficients is greater than the threshold, encoder 20 transitions to using a level coding mode for at least one subsequent coefficient of the scan of the leaf-level unit (604).

FIG. 6 describes techniques that may be used by a coder (e.g., encoder 20, decoder 30) to transition from a run coding mode to a level coding mode. The techniques of FIG. 6 may be used by a coder alone, or together with the techniques of FIG. 7, to transition back and forth between level and run coding modes while coding a unit of video data.

FIG. 7 is a flow diagram that illustrates one example of a method that may be performed by a coder to transition from using a run coding mode to using a level coding mode consistent with one or more aspects of this disclosure. The method of FIG. 7 is described as being performed by encoder 20 below, however any device, including decoder 30 depicted in FIG. 3, may be used to perform the technique of FIG. 7.

According to the example of FIG. 7, encoder 20 (e.g., entropy encoding module 56 depicted in FIG. 2) is operated in a level coding mode to scan transform coefficients of a unit of video data. In the level coding mode, for each coefficient, encoder 20 generates a level syntax element as described above. As shown in FIG. 7, for each coefficient coded in the level mode, encoder 20 determines a number of consecutive coefficients with a magnitude of zero that have been encoded by encoder 20 (701). As also shown in FIG. 7, encoder 20 compares the determined number of consecutive zero value coefficients to a threshold Tᵣᵤₙ (702). As also shown in FIG. 7, if encoder 20 determines that the number of consecutive zero value coefficients is less than or equal to the threshold Tᵣᵤₙ, encoder 20 uses the level coding mode to encode a subsequent coefficient of the scan of the leaf-level unit (703). However, if encoder 20 determines that the number of consecutive zero value coefficients is greater than the threshold, encoder 20 transitions to using a run coding mode for a subsequent coefficient of the scan of the leaf-level unit (704).

In some examples, the thresholds Tᵣᵤₙ and Tₗₑᵥₑₗ described with respect to FIGS. 6 and 7 above may be predetermined thresholds stored in a memory accessible by encoder 20 and decoder 30. In other examples, the thresholds Tᵣᵤₙ and Tₗₑᵥₑₗ may be signaled by encoder 20 to decoder 30 as syntax elements of an entropy encoded bit stream, as described in further detail below with respect to FIGS. 8 and 9 below. In still other examples, the thresholds Tᵣᵤₙ and Tₗₑᵥₑₗ may be automatically determined by encoder 20 and/or decoder 30, as described in further detail below with reference to FIG. 10. Encoder 20 and/or decoder 30 may automatically determine the thresholds Tᵣᵤₙ and Tₗₑᵥₑₗ based on one or more characteristics of the video data being coded, and/or based on one or more collected statistics regarding previously coded video data.

FIG. 8 is a flow diagram that illustrates one example of a method that may be used by an encoder to perform a scan of transform coefficients consistent with one or more aspects of this disclosure. The method of FIG. 8 is described as being performed by encoder 20, however, other devices or encoders may be used to perform the technique of FIG. 8.

As shown in FIG. 8, encoder 20 (e.g., entropy encoding module 56 depicted in FIG. 2) uses a first coding mode to encode a first plurality of coefficients of a unit of video data (801). As also shown in FIG. 8, encoder 20 transitions to using a second coding mode to encode a second plurality of coefficients of the leaf-level unit (802). In some examples, the first coding mode comprises a run coding mode where encoder 20 generates run and level_ID syntax elements for each coefficient, and the second coding mode comprises a level coding mode where encoder 20 generates a level syntax element for each coefficient. In other examples, the first coding mode comprises the level coding mode, and the second coding mode comprises the run coding mode.

As also shown in FIG. 8, encoder 20 generates at least one syntax element that indicates the transition from the first coding mode to the second coding mode (803). For example, the at least one syntax element may indicate the Th_level threshold value and/or the Th_num threshold value described above, which may be used by decoder 30 to transition from a run coding mode to a level coding mode. The Th_level threshold value and/or the Th_num threshold value may be automatically determined by encoder 20 (e.g., based on at least one characteristic of video data and/or at least one statistic related to previously encoded video data) as described below with reference to FIG. 10, and/or determined based on at least one value stored in a memory accessible by encoder 20.

According to other example, encoder 20 may generate at least one syntax element that indicates the Tᵣᵤₙ and Tₗₑᵥₑₗ thresholds described above with respect to FIGS. 6 and 7, which may be used by a decoder to transition from the level coding mode to the run coding mode, or from the run coding mode to the level coding mode. According to these examples, Tᵣᵤₙ threshold value and/or the Tₗₑᵥₑₗ threshold value may be automatically determined by encoder 20 (e.g., based on at least one characteristic of video data and/or at least one statistic related to previously encoded video data) as described below with reference to FIG. 10, and/or determined based on at least one value stored in a memory accessible by encoder 20.

FIG. 9 is a flow diagram that illustrates one example of a method that may used by a decoder to perform a scan of transform coefficients consistent with one or more aspects of this disclosure. The method of FIG. 9 is described as being performed by decoder 30, however other devices or decoders may be used to perform the technique of FIG. 8.

As shown in FIG. 9, decoder 30 (e.g., entropy decoding module 80 depicted in FIG. 3) uses a first coding mode to decode a first plurality of coefficients of a scan of transform coefficients (901). As also shown in FIG. 9, decoder 30 transitions to using a second coding mode to encode a second plurality of coefficients of the scan based on at least one syntax element read by decoder 30 that indicates the transition from the first coding mode to the second coding mode (902). According to one example at least one syntax element may represent the Th_level threshold value and/or the Th_num threshold value described above, which may be used by decoder 30 to transition from a run coding mode to a level coding mode. According to another example, the at least one syntax element may represent the Tᵣᵤₙ and Tₗₑᵥₑₗ thresholds described above with respect to FIGS. 6 and 7, which may be used by decoder 30 to transition from the level coding mode to the run coding mode, or from the run coding mode to the level coding mode. As also shown in FIG. 8, after transitioning to the second coding mode, decoder 30 uses the second coding mode to decode a second plurality of coefficients of the leaf-level unit (903)

In some examples, the first coding mode comprises a run coding mode where decoder 20 reads run and level_ID syntax elements for each coefficient, and uses the received syntax elements to decode the first plurality of coefficients. According to this example, the second coding mode comprises a level coding mode where decoder 30 reads a level syntax element associated with each coefficient, and uses the level syntax element to decode the second plurality of coefficients. In other examples, the first coding mode comprises the level coding mode, and the second coding mode comprises the run coding mode.

In some examples, the at least one syntax element read by decoder 30 that indicates the transition from the first coding mode to the second coding mode comprises the Th_level threshold value and/or the Th_num threshold value described above, which may be used by decoder 30 to transition from a run coding mode to a level coding mode. According to other examples, the at least one syntax element read by decoder 30 that indicates the transition from the first coding mode to the second coding mode comprises the Tᵣᵤₙ and Tₗₑᵥₑₗ thresholds described above with respect to FIGS. 6 and 7, which may be used by decoder 30 to transition from the level coding mode to the run coding mode, or from the run coding mode to the level coding mode, as also described above.

FIG. 10 is a flow diagram that illustrates one example of a method that may be performed by a coder to automatically determine when to transition between using a run coding mode and using a level coding mode consistent with one or more aspects of this disclosure. The method of FIG. 10 is described as being performed by encoder 20 below, however other devices, including decoder 30 depicted in FIG. 3, may be used to perform the technique of FIG. 10.

As shown in FIG. 10, encoder 20 (e.g., entropy encoding module 56 depicted in FIG. 2) automatically determines a value of at least one threshold that indicates a transition between a run coding mode and a level coding mode (1001). In some examples, the threshold may indicate a transition from the run coding mode to the level coding mode. In other examples, the threshold may indicate a transition from the level coding mode to the run coding mode. As also shown in FIG. 10, encoder 20 uses the automatically determined at least one threshold to transition between the run coding mode and the level coding mode, while scanning transform coefficients of a leaf-level unit of video data (1002).

In some examples, the at least one threshold value comprises the Th_level threshold value and/or the Th_num threshold value described above, which may be used by decoder 30 to transition from a run coding mode to a level coding mode. According to other examples, the at least one threshold value comprises the Tᵣᵤₙ and Tₗₑᵥₑₗ thresholds described above with respect to FIGS. 6 and 7, which may be used by a decoder to transition from the level coding mode to the run coding mode, or from the run coding mode to the level coding mode.

In some examples, encoder 20 automatically determines the at least one threshold based on one or more characteristics of video data being encoded. For example, encoder 20 may determine the one or more thresholds based on one or more characteristics such as prediction type (intra or inter-prediction), a type of color component (e.g., luma or chroma), a motion partition (e.g., (2N×N, N×2N or 2N×2N), a size of a motion partition, a size of a transform block, one or more quantization parameters, an amplitude of one or more motion vectors, and/or one or more motion vector predictions, of a frame, slice, divisible unit, and/or leaf-level unit of video data. For example, encoder 20 may use one or more tables stored in memory to map one or more characteristics of video data being encoded to one or more values for the at least one threshold, which encoder 20 may use to transition between run and level coding modes as described herein.

According to another example, encoder 20 may, also or instead, automatically determine such one or more threshold values based on one or more statistics regarding at least one previously coded frame or unit of video data. For example, where the at least one threshold comprises the Th_level and Th_num thresholds described above, if the one or more previously coded frames or blocks have a relatively high percentage of non-zero coefficients, encoder 20 decreases a value of the Th_num threshold such that encoder 20 transition to the level coding mode earlier. On the other hand, if the one or more previously coded frames or blocks have a relatively low percentage of non-zero coefficients, encoder 20 increases a value of the Th_num threshold such that encode transitions later to the level coding mode later.

Decoder 30 may perform reciprocal techniques to those described above with respect to FIG. 10, to decode a leaf-level unit of video data. For example, decoder 30 may transition between using a run coding mode and a level coding mode based on at least one automatically determined threshold as described above with respect to FIG. 10. For example, where encoder 20 is configured to determine at least one threshold that indicates a transition between level and run coding modes based on one or more characteristics of a video data being coded, decoder 30 may determine the same characteristics of video data (e.g., based on header information associated with video data or other means), and use the determined characteristics to automatically determine the at least one threshold used by encoder to encode the video data. According to another example, where encoder 20 is configured to determine the at least one threshold based on statistics related to previously encoded video data, decoder 30 reciprocally collects the same statistics related to previously decoded data, and uses the determined statistics to automatically determine the at least one threshold.

According to other aspects of this disclosure, encoder 20 may automatically determine when to transition between run and level coding modes as described herein based on one or more statistics regarding previously coded coefficients at positions within a coding unit, as opposed to more general statistics regarding the contents of one or more previously coded blocks or frames, as described above. For example, encoder 20 may automatically determine one or more threshold values (e.g., Th_num, Th_level, Tₗₑᵥₑₗ, Tᵣᵤₙ or other threshold) that encoder 20 may use to transition between run and level coding modes based on how often coefficients at positions within previously coded coding units are non-zero. In some examples, encoder 20 may automatically determine when to transition between run and level coding modes as described herein based on one or more statistics regarding previously coded coefficients of a coding unit, specific to the run coding mode or the level coding mode. For example, encoder 20 may adjust one or more thresholds (e.g., Th_num, Th_level, Tᵣᵤₙ, Tₗₑᵥₑₗ or other threshold) that encoder 20 may use to transition between run and level coding modes based on a percentage of coefficients coded in the level mode that are non-zero coefficients. In another example, encoder 20 may also or instead adjust the one or more thresholds (e.g., Th_num, Th_level, Tᵣᵤₙ, Tₗₑᵥₑₗ or other threshold) that the coder may use to transition between run and level coding modes based on a percentage of coefficients coded in the run mode that are non-zero coefficients.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various components, modules, or units may be combined in a codec hardware unit or provided by a collection of interoperative hardware units, including one or more processors as described above, in conjunction with suitable software and/or firmware.

Various examples been described. These and other examples are within the scope of the following claims.

1. A method of coding a block of video data, comprising:
coding at least a first coefficient of a leaf-level unit of video data using a run encoding mode;
coding at least a second coefficient of the leaf-level unit of video data using a level encoding mode; and
after coding the first coefficient using the level coding mode, using the run coding mode to code at least a third coefficient of the leaf-level unit of video data.

2. The method of claim 1, further comprising:
after coding the first at least one coefficient using the level coding mode, using the run coding mode to code at least one other coefficient of the leaf-level unit of video data using the run mode based on at least one threshold.

3. The method of claim 2, wherein the at least one threshold comprises a Tᵣᵤₙ threshold that indicates a number of consecutive coefficients coded in the level mode with a magnitude of zero.

4. The method of claim 3, further comprising:
if a number of consecutively coded coefficients with a magnitude of zero is greater than the Tᵣᵤₙ threshold, transitioning to using the run mode to encode at least one other coefficient of the leaf-level unit.

5. The method of claim 2, wherein the at least one threshold comprises a Tₗₑᵥₑₗ threshold that indicates a number of consecutive coded coefficients coded in the run mode with a non-zero magnitude.

6. The method of claim 5, further comprising:
if a number of consecutively coded coefficients with a non-zero magnitude is greater than the Tₗₑᵥₑₗ threshold, transitioning to using the level mode to encode at least one other coefficient of the leaf-level unit.

7. The method of claim 2, further comprising:
generating a syntax element that indicates the at least one threshold.

8. The method of claim 2, further comprising:
automatically determining the at least one threshold.

9. The method of claim 8, wherein automatically determining the at least one threshold comprises automatically determining based on at least one characteristic of video data being coded, wherein the at least one characteristic is selected from the group consisting of:
a prediction type (intra or inter-prediction),
a type of color component (e.g., luma or chroma),
a motion partition (e.g., (2N×N, N×2N or 2N×2N);
a size of a motion partition;
a size of a transform block;
one or more quantization parameters;
an amplitude of one or more motion vectors; and
one or more motion vector predictions.

10. The method of claim 8, wherein automatically determining the at least one threshold comprises automatically determining based one or more statistics regarding previously coded video data.

11. A device configured to code a block of video data, comprising:
a video coding module configured to:
code at least a first coefficient of a leaf-level unit of video data using a run encoding mode;
code at least a second coefficient of the leaf-level unit of video data using a level encoding mode; and
after coding the second coefficient using the level coding mode, use the run coding mode to code at least a third coefficient of the leaf-level unit of video data.

12. The device of claim 11, wherein the video coding module is further configured to:
after coding the first at least one coefficient using the level coding mode, use the run coding mode to code at least one other coefficient of the leaf-level unit of video data using the run mode based on at least one threshold.

13. The device of claim 12, wherein the at least one threshold comprises a Tᵣᵤₙ threshold that indicates a number of consecutive coefficients coded in the run mode with a magnitude of zero.

14. The device of claim 13, wherein the video coding module is further configured to:
if a number of consecutively coded coefficients with a magnitude of zero is greater than the Tᵣᵤₙ threshold, transition to using the run mode to encode at least one other coefficient of the leaf-level unit.

15. The device of claim 12, wherein the at least one threshold comprises a Tₗₑᵥₑₗ threshold that indicates a number of consecutive coded coefficients coded in the run mode with a non-zero magnitude.

16. The device of claim 15, wherein the video coding module is further configured to:
if a number of consecutively coded coefficients with a magnitude of zero is greater than the Tₗₑᵥₑₗ threshold, transition to using the level mode to encode at least one other coefficient of the leaf-level unit.

17. The device of claim 12, wherein the video coding module is further configured to: generate a syntax element that indicates the at least one threshold.

18. The device of claim 12, wherein the video coding module is further configured to:
automatically determine the at least one threshold.

19. The device of claim 18, wherein the video coding module is further configured to:
automatically determine the at least one threshold comprises automatically determining based on at least one characteristic of video data being coded, wherein the at least one characteristic is selected from the group consisting of:
a prediction type (intra or inter-prediction),
a type of color component (e.g., luma or chroma),
a motion partition (e.g., (2N×N, N×2N or 2N×2N);
a size of a motion partition;
a size of a transform block;
one or more quantization parameters;
an amplitude of one or more motion vectors; and
one or more motion vector predictions.

20. The device of claim 18, wherein the video coding module is further configured to:
automatically determine the at least one threshold comprises automatically determining based one or more statistics regarding previously coded video data.

21. A computer-readable storage medium that stores instructions that, when executed, cause a computing device to:
code at least a first coefficient of a leaf-level unit of video data using a run encoding mode;
code at least a second coefficient of the leaf-level unit of video data using a level encoding mode; and
after coding the second coefficient using the level coding mode, use the run coding mode to code at least a third coefficient of the leaf-level unit of video data.

22. The computer-readable storage medium of claim 21, wherein the instructions are further configured to cause the computing device to:
after coding the first at least one coefficient using the level coding mode, use the run coding mode to code at least one other coefficient of the leaf-level unit of video data using the run mode based on at least one threshold.

23. The computer-readable storage medium of claim 22, wherein the at least one threshold comprises a Tᵣᵤₙ threshold that indicates a number of consecutive coefficients coded in the run mode with a magnitude of zero.

24. The computer-readable storage medium of claim 23, wherein the instructions are further configured to cause the computing device to:
if a number of consecutively coded coefficients with a magnitude of zero is greater than the Tᵣᵤₙ threshold, transition to using the run mode to encode at least one other coefficient of the leaf-level unit.

25. The computer-readable storage medium of claim 22, wherein the at least one threshold comprises a Tₗₑᵥₑₗ threshold that indicates a number of consecutive coded coefficients coded in the level mode with a non-zero magnitude.

26. The computer-readable storage medium of claim 25, wherein the instructions are further configured to cause the computing device to:
if a number of consecutively coded coefficients with a magnitude of zero is greater than the Tₗₑᵥₑₗ threshold, transition to using the level mode to encode at least one other coefficient of the leaf-level unit.

27. The computer-readable storage medium of claim 22, wherein the instructions are further configured to cause the computing device to:
generate a syntax element that indicates the at least one threshold.

28. The computer-readable storage medium of claim 22, wherein the instructions are further configured to cause the computing device to:
automatically determine the at least one threshold.

29. The computer-readable storage medium of claim 28, wherein the instructions are further configured to cause the computing device to:
automatically determine the at least one threshold comprises automatically determining based on at least one characteristic of video data being coded, wherein the at least one characteristic is selected from the group consisting of:
a prediction type (intra or inter-prediction),
a type of color component (e.g., luma or chroma),
a motion partition (e.g., (2N×N, N×2N or 2N×2N);
a size of a motion partition;
a size of a transform block;
one or more quantization parameters;
an amplitude of one or more motion vectors; and
one or more motion vector predictions.

30. The computer-readable storage medium of claim 28, wherein the instructions are further configured to cause the computing device to:
automatically determine the at least one threshold comprises automatically determining based one or more statistics regarding previously coded video data.

31. A device configured to code a block of video data, comprising:
means for coding at least a first coefficient of a leaf-level unit of video data using a run encoding mode;
means for coding at least a second coefficient of the leaf-level unit of video data using a level encoding mode; and
means for, after coding the second coefficient using the level coding mode, using the run coding mode to code at least a third coefficient of the leaf-level unit of video data.

32. The device of claim 31, further comprising:
means for after coding the first at least one coefficient using the level coding mode, using the run coding mode to code at least one other coefficient of the leaf-level unit of video data using the run mode based on at least one threshold.

33. The device of claim 32, wherein the at least one threshold comprises a Tᵣᵤₙ threshold that indicates a number of consecutive coefficients coded in the run mode with a magnitude of zero.

34. The device of claim 33, further comprising:
means for, if a number of consecutively coded coefficients with a magnitude of zero is greater than the Tᵣᵤₙ threshold, transitioning to using the run mode to encode at least one other coefficient of the leaf-level unit.

35. The device of claim 32, wherein the at least one threshold comprises a Tₗₑᵥₑₗ threshold that indicates a number of consecutive coded coefficients coded in the level mode with a non-zero magnitude.

36. The device of claim 35, further comprising:
means for, if a number of consecutively coded coefficients with a magnitude of zero is greater than the Tₗₑᵥₑₗ threshold, transitioning to using the level mode to encode at least one other coefficient of the leaf-level unit.

37. The device of claim 32, further comprising:
means for generating a syntax element that indicates the at least one threshold.

38. The device of claim 32, further comprising:
means for automatically determining the at least one threshold.

39. The device of claim 38, wherein automatically determining the at least one threshold comprises automatically determining based on at least one characteristic of video data being coded, wherein the at least one characteristic is selected from the group consisting of:
a prediction type (intra or inter-prediction),
a type of color component (e.g., luma or chroma),
a motion partition (e.g., (2N×N, N×2N or 2N×2N);
a size of a motion partition;
a size of a transform block;
one or more quantization parameters;
an amplitude of one or more motion vectors; and
one or more motion vector predictions.

40. The device of claim 38, wherein automatically determining the at least one threshold comprises automatically determining based one or more statistics regarding previously coded video data.

41-120. (canceled)
